(19) United States
(12) Patent Application Publication
(10) Pub. No.: US 2019/0178276 A1
(43) Pub. Date: Jun. 13, 2019

(54) Design and Methods for a Modular Construction Kit

(71) Applicant: John Valdemar Hansen, Sydney (AU)

(72) Inventor: John Valdemar Hansen, Sydney (AU)

(21) Appl. No.: 16/215,681

(22) Filed: Dec. 11, 2018

Related U.S. Application Data
(60) Provisional application No. 62/597,369, filed on Dec. 11, 2017.

(51) Int. Cl. F16B 7/18; F16B 7/00; E04B 1/19; E04B 1/32

(52) U.S. Cl. CPC F16B 7/185; F16B 7/00; E04B 2001/0053; E04B 1/32; E04B 1/1903

(57) ABSTRACT

A method for using modular items arranged as a system to connect easily available mostly inexpensive, bulky materials sourced elsewhere for the purpose of constructing objects of a person's own or another's design. The modular items work as an interlocking system that allows a wide range of options for securely connecting hoses, timber, pipes, plastic, metal and plywood sheets together as well as allowing various degrees of freedom of movement where required. Among other methods, connectors comprised of specialized sections that connect with each other as well as various base sections via inserts, lugs or other means are used to quickly assemble a designed item.

### REFERENCE TO RELATED APPLICATIONS

This application claims an invention which was disclosed in Provisional Application No. 62/597,369, filed 11 Dec. 2017, entitled “Design and Methods for a Modular Construction Kit”. The benefit under 35 USC § 119(e) of the United States provisional application is hereby claimed, and the aforementioned application is hereby incorporated herein by reference

### FIELD OF THE INVENTION

The present invention relates to Modular Construction Kits or Systems and specifically to specialty, lightweight, small parts that complement each other and enable construction using independently sourced bulk items.

### BACKGROUND OF THE INVENTION

The current state of construction of self-designed or public domain designs often involves using parts that are expensive and difficult to integrate or have large transport costs for bulky items that might be required.

Some non-exclusionary examples are the design and construction of domes or frames for outside storage, tool hangers, garden trellises or lightweight supports for children's play structures, playhouses or clubhouses. The present disclosure seeks to incorporate a modular system of specialty parts designed to allow for both standardized and proprietary members that can work together with commonly available easily sourced materials like plastic tubing such as PVC, PEX and HDPE or metal such as aluminum or steel conduits, irrigation or sanitary pipes or plywood and plastic sheets which are available from many hardware stores or other outlets. Having small quantities of some of these bulky objects delivered or including them in a full construction kit however can raise the project cost above a desired budget.

This disclosure seeks to provide inexpensive modular systems that can help connect, support or assemble such designed items while leaving the large and bulky items that are nevertheless cheap to manufacture and readily available to be sourced at a local supplier. Many connectors and or supports for such materials are designed for a specific use so that connectors of pipes often must be hollow to allow fluid or wires to pass through and be of sanitary grade and a tight tolerance. However, in use for an alternate purpose, a specialty modular connecting system can incorporate plugs, caps, linkages, inserts or items that are not suitable for the materials original intended purpose but are therefore cheaper to manufacture and available for a wider range of functions.

### BRIEF SUMMARY OF THE DISCLOSURE

The present invention comprises various items used as a modular system for connecting and securing construction items in place to build a physical item from a design. These include but are not limited to connectors and linkages that can be assembled with different configurations and properties for securing pipes, conduits, frames, sheets and panels of various materials together in a quick and secure fashion while allowing movement along specified degrees of freedom if required.

One embodiment of the disclosure is a connector section comprising a collar for various sized pipes, tubes and conduits that can be secured to an insert section acting as a connector for either the same or different sized pipe, tube or conduit using said pipes and conduits as structural members in a construction. Said collar-insert component then can attach one or more members at right angles, or with an adjustable pivot linkage, at various angles to the collared member.

Both the collar and the insert whether pivoted or not form a connector unit which is modular in its nature and function. The collar can be connected to other collars of similar or differing types and sizes. The inserts likewise can be connected to other inserts of similar or differing types and sizes. One embodiment is for the collar to be replaced with a hub from which structural members like pipes can be connected from the top and bottom as well as the sides again in various size combinations and angles.

The insert connectors attached to either collar or hub can be replaced with connectors that are external fittings rather than inserts and attach to the outer surface of the connecting structural member or pipe. The various connector types can join to the various collar or hub types with a variety of joiners some as lugs and complementary slots or cavities others as threaded connectors, clips or other linkage methods.

### BRIEF DESCRIPTION OF THE DRAWINGS

The inventive principals are illustrated in the figures of the accompanying drawings which are meant to be exemplary and not limiting, in which like references are intended to refer to like or corresponding parts and similar elements and in which:

FIG. 1 presents an example of a hub comprised of top and bottom sections and circumferential connectors joined via a separate bolt.

FIG. 2 shows an example of a pivot angle linkage.

FIG. 3 illustrates an example of a hub with spring clip fasteners that connect top and bottom sections and pivoting linkages for insert connectors that can be locked in at a set angle on the hub.

FIG. 4 presents Hubs with cavities that allow insert connectors to attach.

FIG. 5 illustrates a hub comprising top and bottom sections held in place with machine screws

FIG. 6 presents a hub with pivot insert connectors and various locking mechanisms.

FIG. 7 shows an example of a ratcheting pivot connector.

FIG. 8 illustrates a collar with an internal cavity for separate bolts or other fasteners that project out from the collar, the collar being held together via spring clips.

FIG. 9 presents a circumferential connector with a bolt and lock nut.

FIG. 10 shows a collar with an internal recessed groove and a bolt fastener.

FIG. 11 illustrates a Y profiled connector for differing internal diameter pipes.

### DETAILED DESCRIPTION AND BEST MODE OF IMPLEMENTATION

While exemplary embodiment's are described below, it is not intended that these embodiment's describe all possible forms of the embodiment's of the disclosure. Rather, the words used in the specification are words of description rather than limitation, and it is understood that various changes may be made without departing from the spirit and scope of the disclosure. In addition, modifications may be made without departing from the essential teachings of the disclosure. Furthermore, the features of various implementing embodiment's may be combined to form further embodiment's of the disclosure.

Furthermore, to the extent that the term “includes” is used in either the detailed description or any claims, such term is intended to be inclusive in a manner similar to the term “comprising” as comprising is interpreted when employed as a transitional word in a claim. While the disclosure has been described with reference to specific embodiment's, those skilled in the art will understand that various changes may be made and equivalents may be substituted for elements thereof without departing from the true spirit and scope of the disclosure.

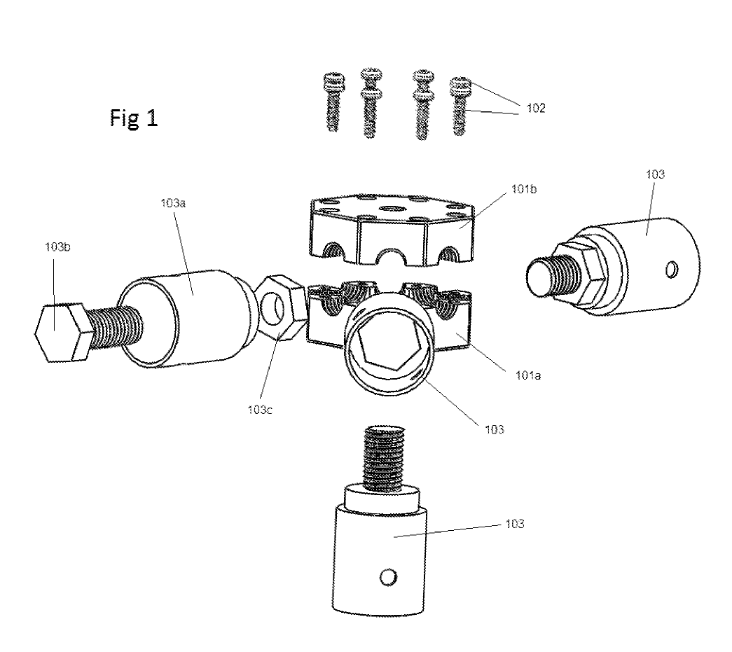

Referring to FIG. 1 which shows an embodiment of a modular system which can be used for connecting pipes or tubes via their outside diameter by way of a circumferential connector 103a which has a bolt 103b and nut 103c inserted that can thread into a hub comprising of top 101b and bottom 101a sections. The hub is held together via machine screws 102 which secure the hub sections as one unit. An assembled connector with nuts 103 is shown both separated and in connected position with the hub.

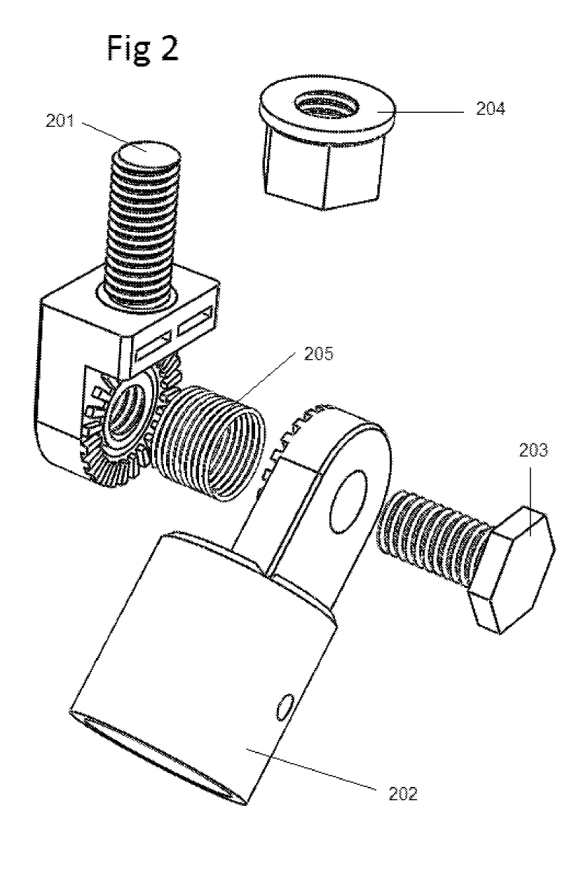

Also referring to FIG. 2 which illustrates a pivot linkage connector one component of which is threaded 201 and one which is a circumferential connector 202 connected by nut 204 and bolt 203 with a spring 205 arranged to allow separation for angle adjustment when the bolt and nut are loosened. The components can obviously be changed to two threaded components or two circumferential connector components or other type such as internal connectors or various components designed for particular members and retained at a set angle relative to each other.

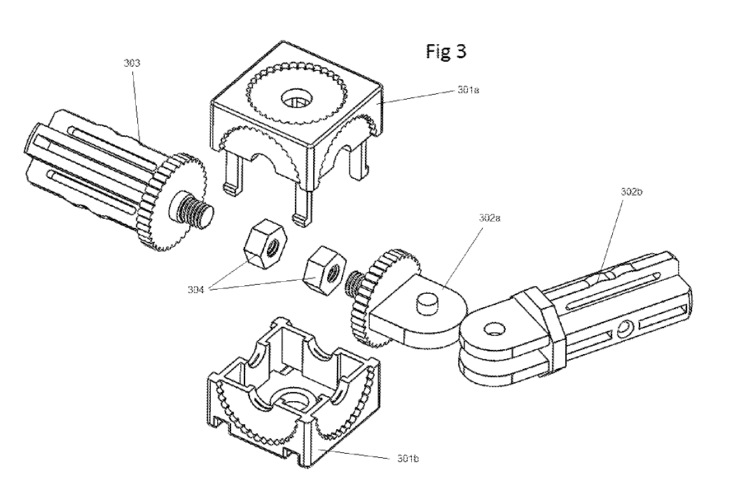

Yet another embodiment is shown in FIG. 3 where cubic hub sections 301a and 301b are connected together via integral spring clips. A pivot connector comprising a pivot base 302a is attached by integral threaded shafts and a nut 304 to the hub and an insert connector 302b is attached to the base pivot 302a. This allows for hinges and a wide range of movement for the connected members. Another insert connector 303 is shown as a fixed 90 degree connector.

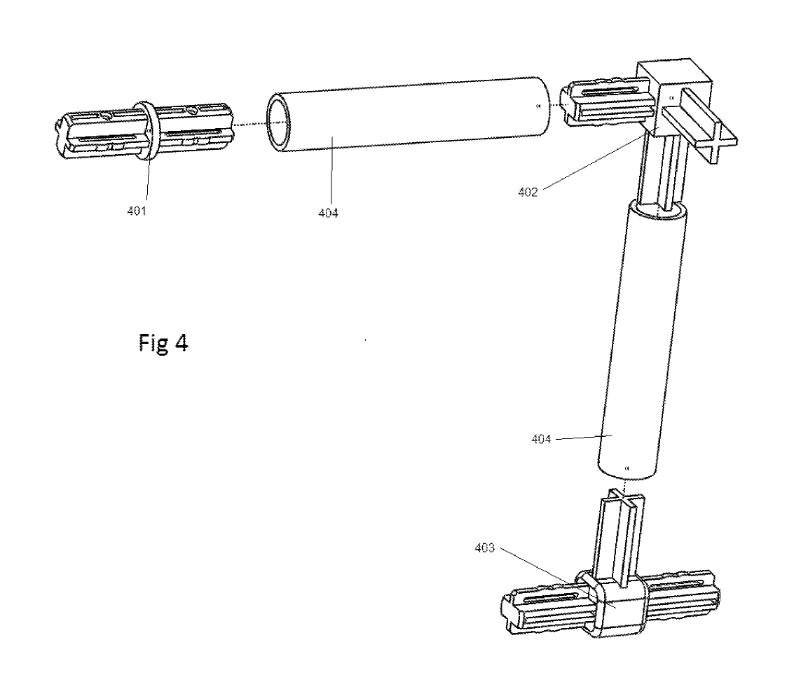

Referring to FIG. 4 the combination of inserts, hubs, collars and linkages 401 can include solid hubs 402 and 403 with cavities that match inserts or other connection components that are made for standardized off the shelf items like PVC conduit 404 or other common building or household supplies.

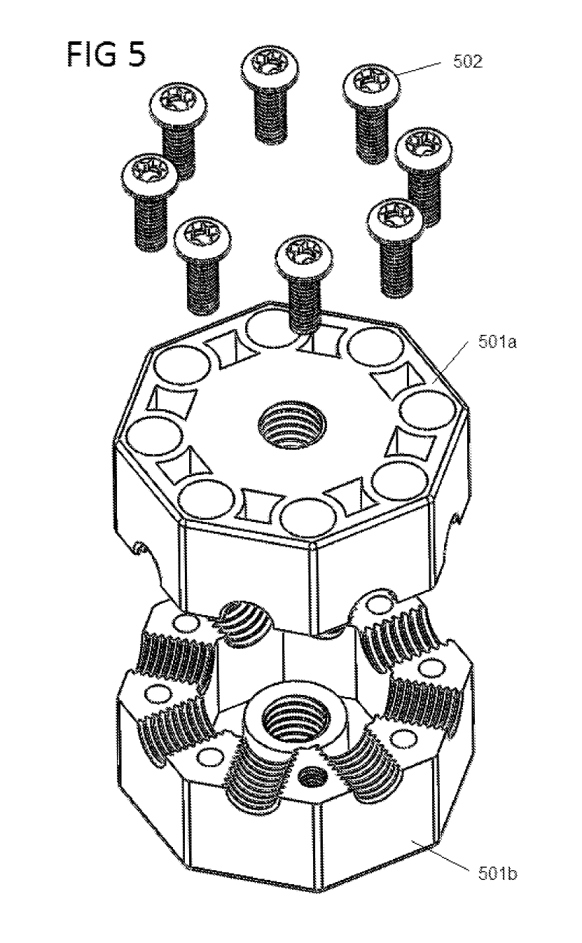

As shown in FIG. 5 one embodiment is a hub arranged as a pair of complementary octagonal sections that allow a threaded insert. The hub sections 501a and 501b are assembled with machine screws 502 to form a working hub. The shape of the hub could be pentagonal, a decagon any polygonal shape or any regular or irregular polyhedra. The hubs can contain threads for screwing or clips or sockets like a bayonet socket depending on intended use, reuse and structural requirements.

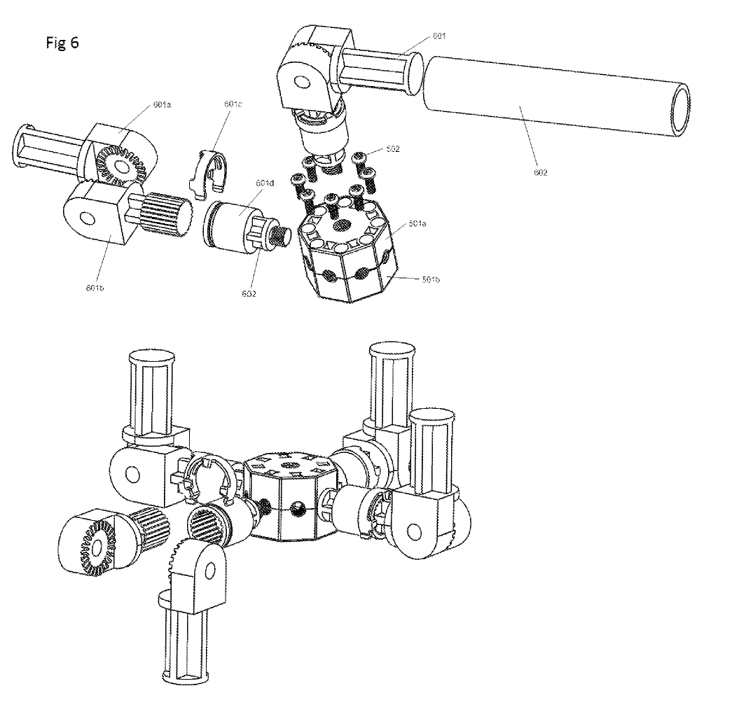

Referring to FIG. 6 several locking mechanisms can be used including but not limited to threaded sections and lock nuts, pins, cir-clips, bolts, screws or glue and items like Velcro or magnets. An angled pivot connector section 601a is mated with another angled connector which has a ribbed barrel 601b which fits a threaded female barrel connector 601d which uses a clip 601c to hold the two male and female sections in place both radially and longitudinally. This holds the connected structural member in place at a set angle with two degrees of freedom for its orientation. The assembled connector 601 can rigidly connect to a pipe 602 at a wide range of orientations.

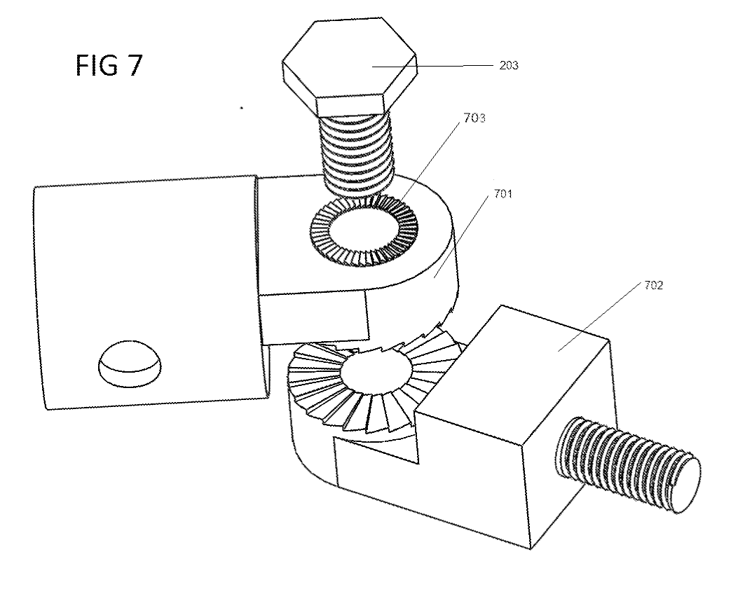

FIG. 7 shows another embodiment of a pivoting connection with sections 701 and 702 where the joint can ratchet in one direction and not in the reverse as well as lock washers 703 and bolts 203 to hold them together.

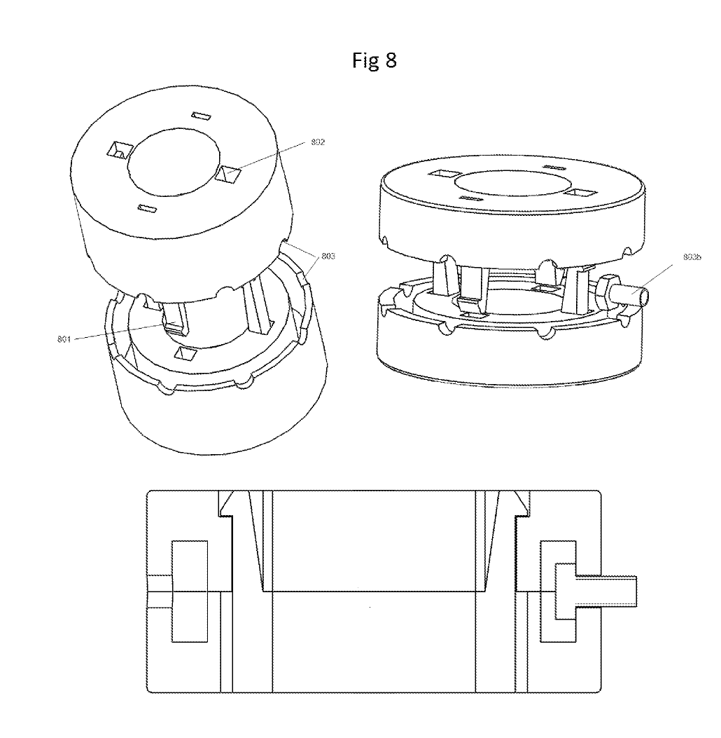

A further embodiment is displayed in FIG. 8 for a circular collar with a cavity for bolts, nuts, lugs or other fastener types, The sections 801 are integral spring clips and 802 is the cavity it slides into to lock the two sections in place. The two sections are the same but offset 90 degrees to allow the four integral spring clips to lock the sections in place rather than machine screws. Holes 803 are at positions around the perimeter and others can be drilled at any position to allow an infinite range of angles between connectors such as 803b and thus the structural members connecting to them.

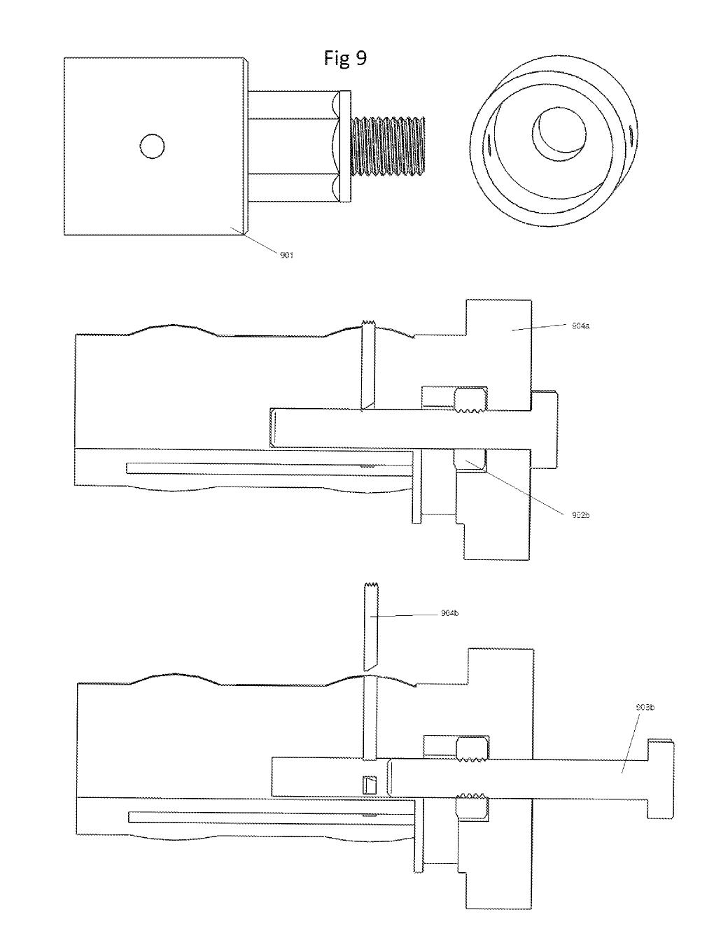

FIG. 9 shows a circumferential connector with hole for various size bolts and a lock nut retaining it in place. Two holes on the barrel of the connector allow fixing the pipe or conduit to the barrel with screws through the pipe or button type spring clips. There is also an embodiment of an insert component 904b which has a sliding section 904b that can extend and hold the inner surface of a pipe via the action of a bolt 903b and nut 902b

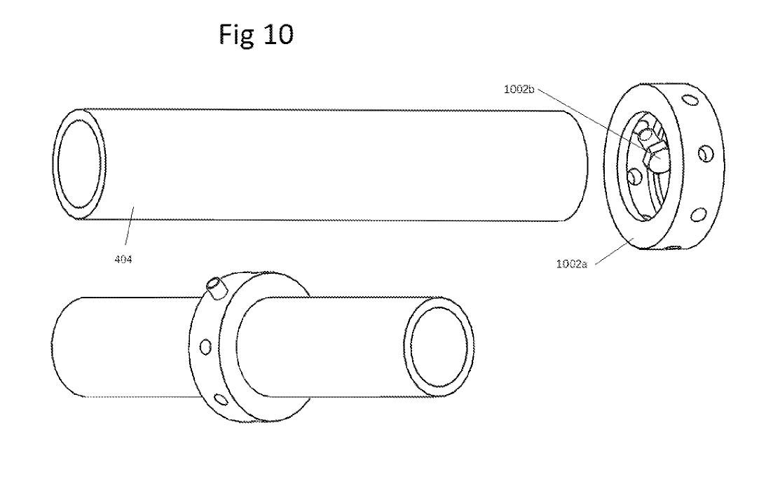

FIG. 10 shows an embodiment as a simple collar 1002a which fits a particular diameter structural section and has an inner recessed grove where a bolt or other fastener can be positioned. Again this embodiment allows any angle between attached structural members 404 and can be easily adapted with drilling for any angle between fasteners such as bolts 1002b.

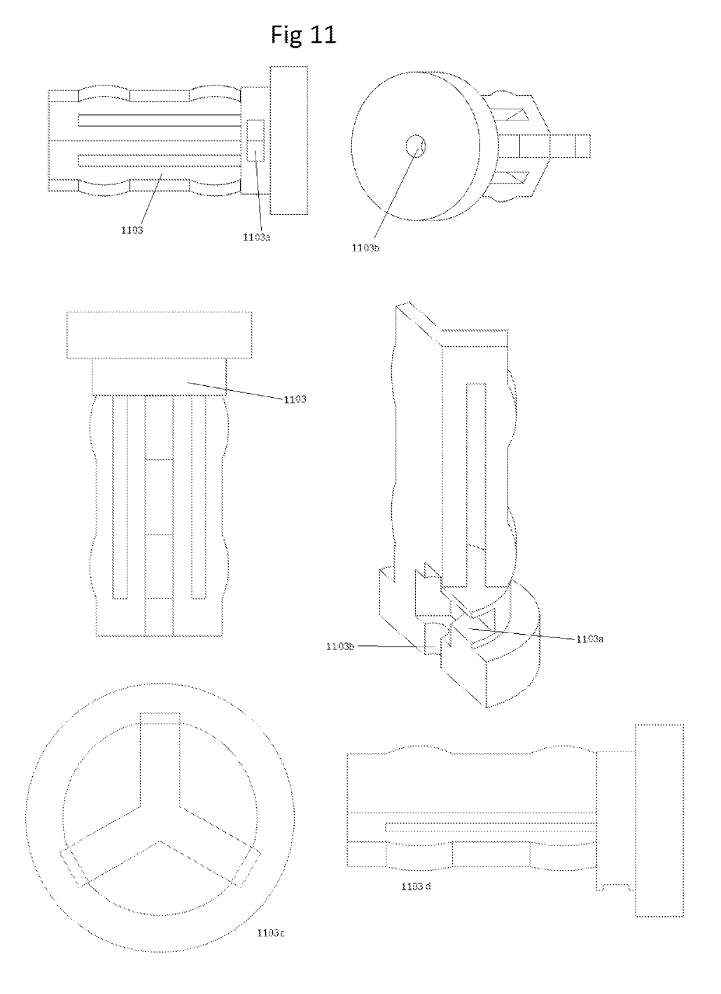

Referring to FIG. 11 we illustrate a Y profile insert connector 1103 for a range of diameter tubes. The insert connector has a hole for a fastener shaft 1103b and a slot for a nut to suit 1103a the Y cross section allows three contact areas on the inner diameter of a tube while ridges on the blades allow contact points to have pressure applied on the inner faces of said tubes. Slots in two of the blades allow flexibility for the ridges to compress down on the blades which supplies a spring like force of the blades and ridges onto the tubes inner surface.

All connector types in the described embodiment's are designed for use on both ISO “International Organization for Standardization” and ANSI “American Standards Association” pipes and conduits as well as proprietary “structural grade” and specialized plastic and metal tubing and structural members.

One of our preferred embodiment's is for connectors that enable a selection of domes commonly referred to as Geodesic. These can comprise hubs that are of the correct angle and number of joins but allow the connection of plugs via inserts that then form the vertex connector set proper. Although the term Geodesic is used here generically many dome shapes are possible using a variety of connectors and one preferred embodiment is the series of geometric forms known as Platonic solids.

Some of these are the Dodecahedron and Icosahedron or geometric form comprising the Archimedean solids like the Truncated Icosahedron, Rhombicosidodecahedron or Truncated Icosidodecahedron. These can be used to provide dome shapes that have regular polygons making up their surface and importantly have edges that are all the same size. This allows users of the connectors to cut a set number of identical pipes or frame sections for use as the sides with no problems of distinguishing which members to use as they are all the same. Although the preferred embodiment uses geometric solids true Geodesic dome connectors made from modular sections can be included in many embodiment's.

One possible embodiment is the Truncated Icosahedron which is commonly identified as a shape used in soccer balls and made of regularly arranged pentagon and hexagon sections where only 3 edges ever meet at a vertex and the same hub can be used for the entire structure. The same is true for a truncated octahedron but it has less of a dome shape. We implement this embodiment by using an insert connector with the required angles and orientation for each of those geometric solids and connecting plugs to allow pipes to be used for the framework.

For sheets and non tubular items connectors with slots and adjustable faces such as used in vice or clamps as well as clips that hold onto the exterior of a pipe or tube and allow flexible attachment with items like cable ties and various bands or straps of metal or plastic.

What is claimed is:

1. A connection system for assembling frames and structures based on standard ANSI, OSI and proprietary pipes, conduits and other bulk items utilizing modular connectors comprised of inserts, collars, hubs, pivots and other non standard connections not made for such pipes and conduits main intended use.

2. A hub assembly as in claim 1 comprising of one or more attachment points to anchor an item suitable as an internal or external connector to structural members composed of such pipes conduits and tubes s well as non structural items like plastic, plywood or cloth sheeting.

3. A collar assembly as in the hub of claim 2 that fits over the outside diameter of a pipe, conduit or tube and provides anchor points for either other collars or items suitable as an internal or external connector to structural members composed of pipes, conduits, tubes as well as non structural items like plastic, plywood or cloth sheeting.

4. Various modular interior and exterior connectors as in claim 1 for structural members made from standardized pipe, tubes or conduit and comprising rigid connections as well as pivot arms with degrees of freedom and locking systems to prevent unwanted movement and deviation from a desired orientation.
